(19) United States
(12) Patent Application Publication
(10) Pub. No.: US 2003/0205257 A1
(43) Pub. Date: Nov. 6, 2003

(54) Washing facility

(76) Inventor: Terry R. Gross, Timber Lake, SD (US)

Correspondence Address: Jacobson & Johnson, Suite 285, One West Water Street, St Paul, MN, 55107-2033, US

(21) Appl. No.: 10/241,949

(22) PCT Filed: Dec. 12, 2000
(86) PCT No.: PCT/US00/33608

(51) Int. Cl. B08B 3/00

(52) U.S. Cl. 134/123

(57) ABSTRACT

An apparatus (10) is provided for collecting runoff from a vehicle (12) as it is being washed which is arranged for use with a conventional mobile ramp structure (14) similar to those which are used by some military personnel when servicing vehicles in the field. The ramp structure (14) includes a pair of upwardly extending, parallel and spaced apart ramps (16). The apparatus (10) includes a trough (44) mounted between the ramps (16) and a plurality of canals (70) extending longitudinally with the ramps (16) for collecting runoff thereon and diverting the runoff into a settling tank (86). A solid particle separator (46) removes solid particles from the settling tank (86) while a pumping station (114) recycles the fluid in the settling tank (86) so that it may be redirected at a vehicle (12) supported on the ramps (16) by a high pressure sprayer arrangement (60, 64).

### FIELD OF THE INVENTION

This invention relates to an apparatus for collecting liquid runoff from an object being washed and more particularly to an apparatus for collecting liquid and debris runoff from a vehicle being washed.

### BACKGROUND

When using vehicles in environments in which the vehicle may be exposed to contaminants it is desirable to subsequently wash down the vehicle. These contaminants may occasionally he of a toxic nature and care must be exercised in protecting individuals who are responsible for cleaning the vehicles. This is generally accomplished by supporting the vehicle on a platform or ramp structure such that the undercarriage of the vehicle is easily washed down by individuals who are outfitted in protective suits. The runoff from the vehicle however contains numerous contaminants washed from the vehicle and can therefore be harmful o the surrounding environment if not properly collected. The runoff may also include solid debris in the form of earth particles, for example mud and rocks, which must be cleansed from the vehicle for proper maintenance of the vehicle. It is also desirable to collect water used to wash the vehicles for reuse to reduce the overall amount of water required to wash a given number of vehicles.

### SUMMARY

According to the present invention there is provided an apparatus for collecting liquid and debris runoff from a vehicle, the apparatus comprising:

a ramp structure having a pair of parallel and spaced apart ramps defining an opening therebetween extending in a longitudinal direction of the ramps and being arranged to support the vehicle thereon;

a primary collector spanning across the opening between the ramps such that substantially all liquid and debris falling between the ramps is collected by the primary collector;

a secondary collector spanning between respective sides of each ramp such that substantially all liquid and debris falling on the ramps is collected by the secondary collectors; and

a discharge associated with each collector for diverting liquid and debris collected by the respective collectors therethrough.

The apparatus is thus arranged to collect liquid and debris runoff from a vehicle supported thereon as the vehicle is being washed. The apparatus is thus ideal for situations where the runoff includes contaminants which may be harmful to the environment as well as situations where there is a limited supply of water for washing the vehicles. Diverting both liquid and debris runoff through the collectors allows the apparatus to collect various forms of debris including mud, rocks, grease, oil and other forms of earth particles.

The ramp structure preferably extends at an upward incline from a bottom end to a top end, the discharge of each collector being located adjacent the bottom end of the ramp structure.

The primary collector preferably comprises a longitudinally extending trough wherein the corresponding discharge comprises an open end of the trough. There may be provided a common collection tank in communication with the discharges of the respective collectors, the discharges of the respective collectors being spaced upwardly from the bottom end of the ramp structure so as to receive the common collection tank there below.

The primary collector may comprise a plurality of sections mounted adjacent to each other, each section being selectively separable from the ramp structure. With the ramp structure extending at an upward incline from a bottom end to a top end, a bottom end of each section is preferably arranged to overlap a top end of an adjacent section.

The primary collector preferably spans laterally between a pair of longitudinally extending sides with the sides being arranged to be supported on the ramps respectively.

When each ramp comprises a plurality of longitudinally extending, parallel and spaced apart beams, each secondary collector preferably comprises a plurality of longitudinally extending canals mounted between the respective beams of the corresponding ramp.

When the beams comprise I-beams having laterally extending flanges adjacent a top end thereof, the canals preferably each having a pair of sides extending upwardly and outwardly beneath the respective flanges of adjacent beams.

Each secondary collector preferably includes a respective flushing system mounted adjacent a top end thereof arranged to direct a flow of flushing fluid through the respective secondary collector from the top end to the discharge thereof.

There may be provided a spray cart supported between the ramps for rolling movement in a longitudinal direction of the ramps. The spray cart has a plurality of upwardly extending nozzles for direction a flow of fluid upwardly to engage a vehicle supported on the ramp structure.

In one embodiment, the primary collector may comprise a rigid trough having a pair of longitudinally extending rails formed integrally therein for supporting the spray cart for longitudinal rolling movement along the rails of the trough.

Alternatively, the spray cart may be supported by a series of rollers arranged for rolling movement along the ramps. An adjustable mount may then be provided for supporting the rollers on the cart such that the rollers may be supported at any one of numerous lateral spacings therebetween for supporting the cart on ramps having various spacings therebetween.

The primary collector may be formed of a flexible material permitting a width of the primary collector to accommodate various lateral spacings between the ramps. In this arrangement, there may be provided a roller mounted integrally with the primary collector between the ramps and extending in the longitudinal direction of the ramps, the roller being supported for rotation about a longitudinally extending axis so as to permit the primary collector to be rolled up on the roller.

The common collection tank may comprise a settling tank extending between respective first and second ends of the tank, the discharges of the respective collectors being arranged to communicate with the first end of the settling tank. A recycling station is preferably arranged to communicate with the second end of the settling tank. The recycling station includes a pump arrangement for drawing fluid from the settling tank and redirecting the fluid at a vehicle supported on the ramps.

The recycling station may include a liquid separator for separating undesirable liquids from the fluid to be directed at the vehicle.

The settling tank preferably includes a series of baffles mounted at spaced apart locations between the first and second ends of the tank.

There may be provided a slurry pump and solid particle separator coupled to the first end of the settling tank arranged to remove an accumulation of solid particle debris from the first end of the settling tank.

### BRIEF DESCRIPTION OF THE DRAWINGS

In the accompanying drawings, which illustrate exemplary embodiments of the present invention:

FIG. 1 is a side elevational view of the apparatus.

FIG. 2 is a sectional view along the line 2-2 of FIG. 1.

FIG. 3 is a top plan view along the line 3-3 of FIG. 1.

FIG. 4 is a sectional view similar to that of FIG. 2 of an alternate embodiment of the apparatus.

FIG. 5 is a sectional view of a solid particle separator used in conjunction with apparatus of FIG. 1.

FIG. 6 is a schematic side elevations view of a further embodiment of the apparatus.

FIG. 7 is a schematic view illustrating the flow of washing fluid through the apparatus according to FIG. 1.

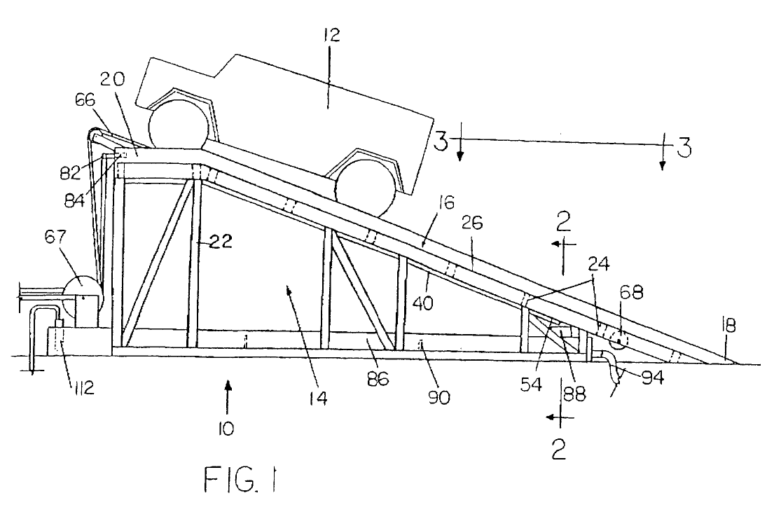

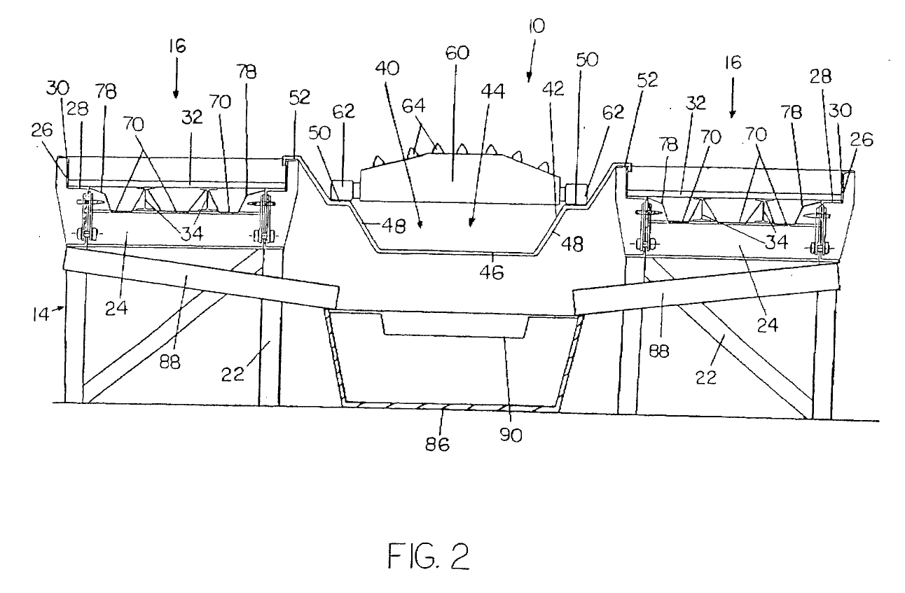

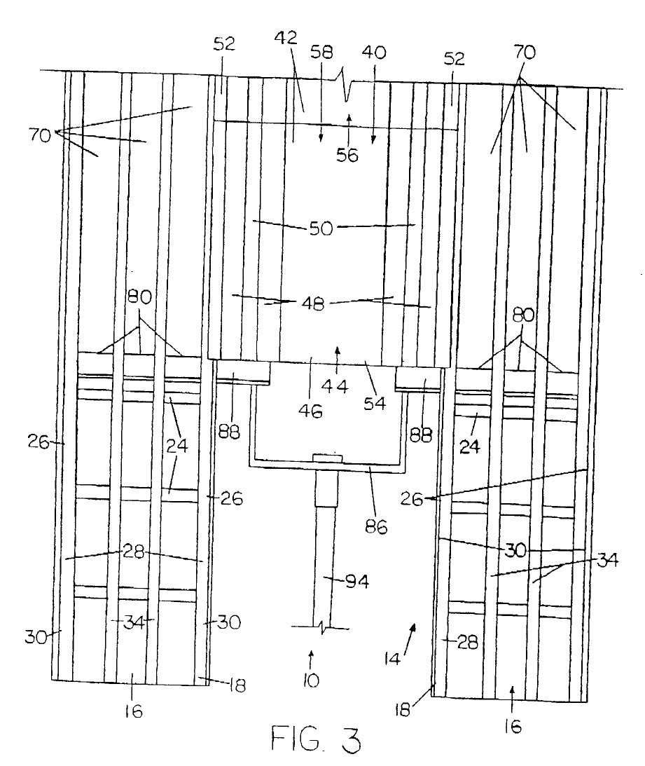

### DETAILED DESCRIPTION

Referring to the accompanying drawings, there is illustrated an apparatus generally indicated by reference numeral 10 for collecting runoff from a vehicle 12 as the vehicle is being washed. The apparatus 10 is arranged for use with a conventional mobile service ramp structure 14 similar to those which are currently used by some military personnel when servicing vehicles in the field.

The ramp structure 14 generally comprises a pair of parallel and spaced apart ramps 16. The ramps extend at an upward incline from a loading end 18 to a free end 20 which is spaced longitudinally and upwardly from the loading end. A frame structure 22 supports the ramps such that each ramp supports a corresponding side of the vehicle 12 thereon. The frame structure 22 is assembled using mounting pins such that the ramp may be readily disassembled and reassembled in sections as desired. Each mounting pin is a tapered pin which is held in place at first end by a head of the pin and secured at a second end by a keeper pin inserted therethrough. The frame structure includes a plurality of mounting apertures such that the ramps may be mounted at various spacings for accommodating various size vehicles thereon.

Each ramp 16, includes a plurality of parallel and longitudinally spaced apart base members 24, having a pair of side members 26 mounted longitudinally along respective ends of the base members. The side members 26 are fastened to the base members 24 such that each ramp 16 defines a generally U-shaped trough between the side members, which is wider than a corresponding tire or track of the vehicle 12. The side members 26 assist in guiding wheels of the vehicle up the corresponding ramp as a vehicle is driven onto the ramp structure.

Each side member 26 includes a shoulder 28 along an inner face 30 thereof. A grill 32 is supported on each ramp 16 to extend between the corresponding side members 26 and supported along respective side edges on the shoulders 28. A plurality of I-beams 34 having a height which is equal to a spacing between a top of the base members 24 and the shoulder 28, are mounted to extend longitudinally within the trough of each ramp 16. The I-beams 34 are parallel and spaced between the corresponding side members 26 such that the respective grills are supported thereon.

The apparatus 10 includes a primary collector 40 which is mounted between the ramps 16 to define a continuous collection surface spanning an opening defined between the ramps. The primary collector 40 is adapted to fit a particular spacing of the ramps corresponding to one of numerous standard sizes of vehicles used thereon.

The primary collector 40 comprises a plurality of sections 42 which are assembled to form a trough 44 extending longitudinally with the ramps. The trough 44 has a flat bottom 46 and a pair of sides 48 which extend at an upward and outward incline to engage a corresponding one of the ramps 16 at a free end thereof. Each side 48 includes a shoulder 50 formed therein to extend laterally inward towards the opposing side at a location spaced upwardly from the bottom 46. A hook portion 52 at the upper free end of each side 48 is arranged to extend over a corresponding side member 26 along an inner side of one of the ramps.

The sections 42 are mounted adjacent to each other from a top end adjacent the free end 20 of the ramps to a open discharge end 54 which is spaced from the loading end 18 of the ramps. Each section 42 is arranged such that a bottom edge 46 overlaps a top edge 58 of the adjacent section.

A spray cart 60 is supported within the trough 44 and includes a set of wheels 62 which are arranged to ride along the shoulder 50 as the spray cart is displaced between the top end and the open discharge end 54 of the trough. The trough is formed of rigid material so as to support the cart on the shoulders 50 which act as integrally formed rails extending in the longitudinal direction of the ramps. The cart 60 includes a plurality of nozzles 64 which extend upwardly at various angles for directing a flow of cleansing fluid or water upwardly to engage an under carriage of the vehicle 12 supported on the ramp structure 14.

A hose reel 67 is mounted at one end of the ramp structure for winding a pressurised feed line 66 thereon which is coupled to the cart 60 to supply a flow of pressurized fluid to the cart as the cart is displaced along the ramp structure by unrolling the feed line from the reel 67. The feed line 66 is a flexible tube member which does not interfere with longitudinal movement of the cart 60 along the trough. A cable is coupled to the opposing end of the cart 60 and wound on a cable reel 68 at a bottom end of the ramp structure for pulling the cart down the trough. The cable reel is driven by a geared air drive motor.

A secondary collector in the form of a plurality of diverter canals 70 is mounted beneath the grill 32 of each ramp 16 to extend longitudinally with the corresponding ramp between corresponding I-beams 34. The secondary collectors span between the sides of the respective ramps. Each diverter canal 70 is a U-shaped trough having a flat bottom and a pair of sides extending at an upward and outward inline therefrom. The sides extend at upward and outward inclines such that an upward free end of each side is located beneath an upper flange of a corresponding one of the I-beams 34.

The canals 70 are thus arranged to collect substantially all of the fluid and debris which drips through the grill 32. An outer side 78 of the corresponding canals 70 located adjacent one of the side members 26 of each ramp 16 is spaced inwardly at a bottom end to accommodate a clearance space for fasteners extending inwardly from the corresponding side members 26. A top end of each outer side 78 includes a flange which extends partially over the corresponding shoulder 28 of the side member 26.

The canals 70 extend longitudinally from the free end 20 of the ramps to an open discharge end 80 adjacent the open discharge end 54 of trough 44 which is spaced from a loading end 18 of the ramps. The open discharge end 80 is located above an opening between an adjacent pair of base members to permit fluid and debris in the canals to flow therethrough.

A canal flushing manifold 82 is mounted adjacent the top end of the ramp structure. The manifold 82 includes a nozzle 84 extending therefrom associated with each of the canals 70 for directing a flow of washing fluid therethrough to assist in rinsing particulate debris collected in the canals through to the discharge end 80.

A settling tank 86 is provided and is arranged for commonly receiving fluid from the discharge of the canals 70 and the trough 44. The settling tank 86 extends longitudinally with the ramps therebetween from a first end located adjacent the respective discharges at a bottom end of the ramps to a respective second end which extends longitudinally beyond the top end of the ramps.

A diverter channel 88 is mounted on a bottom side of each ramp 16 adjacent the discharge end 80 of the corresponding canals 70 to collect the fluid discharged therefrom and divert the fluid into the settling tank 86 at the first end thereof. The diverter channels 88 extend at a downward incline from an outer side to an inner side of the ramps to assist in directing the flow to the centrally located settling tank 86.

The settling tank 86 is formed in three ten foot long sections with each section being separated by a baffle 90 which extends upwardly from the bottom of the tank only partway so as to permit washing fluid to flow over a top end of the baffle when the tank 86 is substantially full of fluid. As the washing fluid migrates from the first end to the second end of the settling tank, travelling over the respective baffles 90, solid particulate matter and sedimentation in the fluid settle to the bottom of the tank and are restricted from displacement between the first and second ends of the tank by the baffles 90. The fluid adjacent the second end of the tank 86 is thus substantially free of solid particulate material.

A slurry pump 92 is arranged to draw a liquid and solid particle slurry from the first end of the settling tank 86 through a feed hose 94. The feed hose 94 supplies the slurry to a particle separator 96 with the assistance of the slurry pump 92. The particle separator 96, which is illustrated in further detail in FIG. 5, is arranged to separate particulate material and sludge such as mud and rocks from the washing fluid and return the cleansed washing fluid back to the settling tank adjacent the first end thereof.

The separator 96 generally comprises a drum 98 having an open top end 100. An outlet of the slurry pump 92 dumps the slurry into the drum 98 through the open top end 100 thereof. A drain 102 located centrally in a bottom of the drum 98 drains the washing fluid from the separator for its return back to the settling tank 86 through the return line 104. Within the drum 98 there is provided a tubular riser 106 mounted about the drain 102 which mounts a filter pipe 108 thereon.

The filter pipe 108 is a slotted pipe which extends upwardly from the riser 106 in sealing and engagement therewith such that fluid must pass through the slots in the filter pipe 108 in order to reach the drain 102. A filter paper surrounds the filter pipe to restrict passage of solid particles in the fluid such that only the fluid is permitted to pass through to the drain and be returned to the settling tank.

In use the particle separator 96 is periodically dumped with the drain 102 being capped so as to permit the drum 98 to be rinsed clean and permit further particulate material to be accumulated therein. An agitator 110 may be provided for stirring up the solid waste in the drum.

Fluid which is returned to the settling tank 86 then migrates from the first end to the second end of the tank with further sedimentation in the fluid being trapped by the baffles as noted above. A submersible pump 112 is submersed at the second end of the tank 86 for pumping the fluid in the settling tank to a recycling station 114.

A makeup water tank 116 adds water to the settling tank as required to maintain the water level in the settling tank in relation to the baffles 90 to permit continued operation of the baffles for collecting sedimentation in the tank.

The recycling station 114 includes an array of pumps for directing a high pressure flow of recycled water to the spray cart 60 and the canal flushing manifold 82. The recycling station further includes an oil liquid separator and additional particle filters when required. An electrical control system and compressor are further provided for controlling operation of all the pumps and the cable reel 68. The recycling station thus enables the apparatus 10 to be operated as a closed loop system.

In use a vehicle is first driven up onto the ramps 16 for being washed thereon. The submersible pump 112 is first started and acts as a primer pump for priming the array of pumps located in the recycling station 114. Once the recycling station 114 has been primed, the high pressure flow of recycled fluid is directed to the manifold 82 for flushing the canals 70 thus beginning the cycling process of the washing fluid. The spray cart 60 is positioned adjacent the top end of the ramps and the appropriate valves are opened so as to direct a high pressure flow through the nozzles thereon for cleansing the undercarriage of the vehicle. Additional spray wands may be supplied with high pressure water from the recycle station as well for rinsing additional parts of the vehicle inaccessible by the spray cart 60.

Using the cable reel 68, the cart 60 is pulled along the ramps towards the bottom end thereof at a sufficiently slow and steady pace to thoroughly clean the vehicle. Liquid run off and particle debris washed from the vehicle are collected in the trough 44 and the canals 70 so as to be flushed through the respective discharges into the settling tank 86 at the first end thereof adjacent the bottom end of the tank.

The particle separator 96 is used to collect solid debris which accumulates at the first end of the settling tank and returns the washing fluid to the tank once the particulate material has been removed therefrom. The fluid thus joins the flow of fluid over the baffles from the first end to the second end of the tank where the submersible pump 112 pumps the fluid to the recycling station for supplying fluid to the pressurized nozzles of the manifold 82 and the cart 60.

The oil separator and additional particle filtering at the recycling station may be used as required. Make up water is added from the make up water tank 116 to the second end of the settling tank automatically using a float valve to maintain the level of fluid in the settling tank 86 at a constant level.

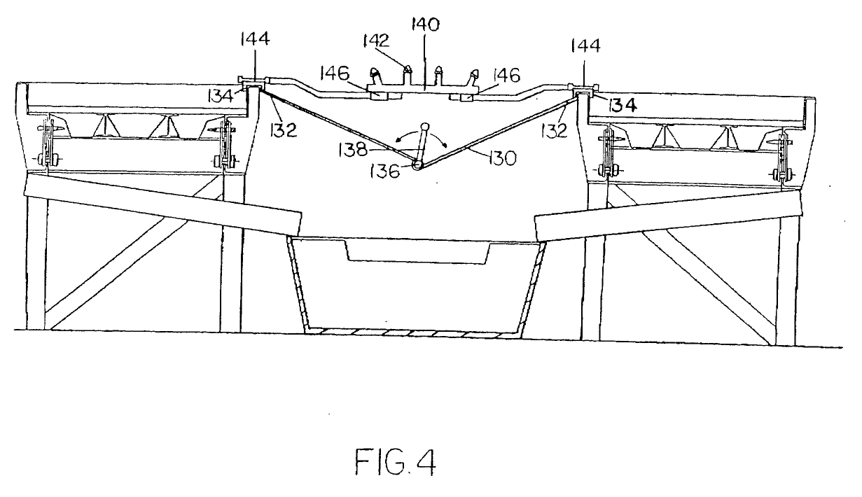

An alternate embodiment is illustrated in FIG. 4 wherein there is provided a trough 130 which is adjustable in width for accommodating various lateral spacings between the ramps 16 when used for washing vehicles of different widths. The trough 130 is formed of a sheet of flexible waterproof material which extends in a longitudinal direction of the ramp and spans laterally between respective sides 132 hich are suspended from the ramps 16 respectively. Each side 132 of the trough 30 is secured by a clamp member 134 which extends over a respective inner side of he corresponding ramp 16.

A roller 136 is mounted intregally within the sheet of flexible material forming the trough 130 and extends in the longitudinal direction of the ramps. The roller 136 is supported for rotation about a longitudinal axis thereof such that rotation of the roller will cause the sheet forming the trough 130 to be rolled up thereon thus shortening the overall width of the trough between respective sides 132 thereof. A manually operated crank 138 may be mounted on one end of the roller 136 for manually operating rotation of the roller 136 and thus the width of the trough 130.

In addition to the trough 130 which is adjustable in width, a spray cart 140 is provided which is arranged to be supported directly on the ramps 116 and is also adjustable in width. The cart 140 includes a plurality of nozzles 142 for directing the high pressure flow of recycled washing fluid therethrough similarly to the previous embodiment. The cart 140 is supported on the respective inner sides of the ramps 16 by a series of rollers 144 which are mounted on the cart 140 by an adjustable bracket 146. The bracket 146 mounts each set of rollers 144 for lateral sliding movement in relation to the cart 140 so as to permit the overall lateral width of the cart 140 to be adjusted for accommodating various lateral spacings of the ramps. With the exception of the additional feature of permitting the width to be adjusted, the trough 130 an the cart 140 operate similarly to the apparatus 10 of the previous embodiment.

The troughs and the diverter canals 70 are each formed of a durable plastic material for containing and collecting contaminants of a toxic nature without corroding the ramp structure 14 or spilling corrosive materials therein into the surrounding environment. Variations in the size and shape of the canals and troughs allows the apparatus to be used on ramps of varying size for use with larger vehicles such as tanks or for smaller personal vehicles.

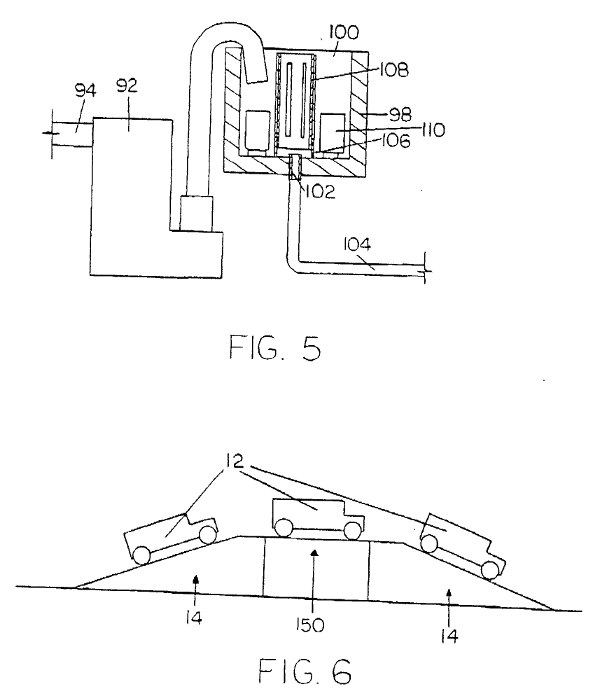

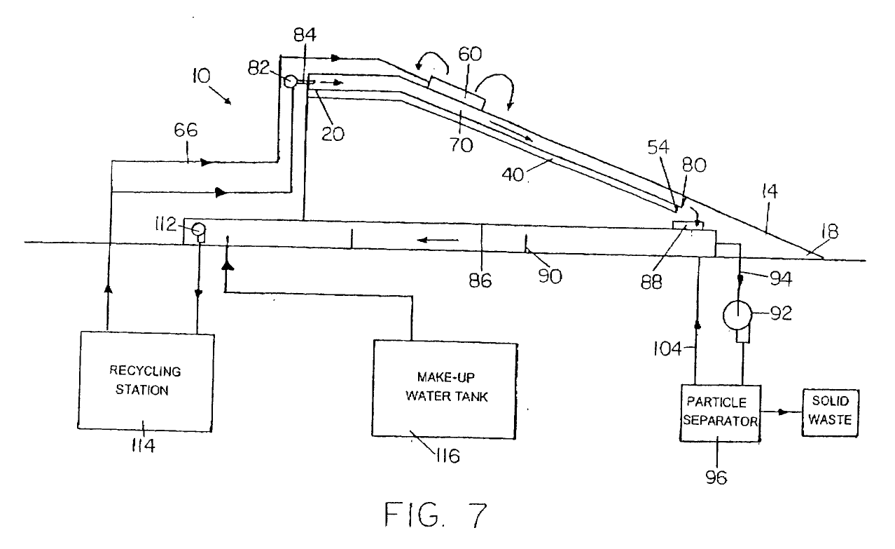

In another arrangement of the present invention as illustrated in FIG. 6 a pair of ramp structures 14 may be supported with the respective free ends of the ramps being connected by a bridging element 150 to form a continuous ramp surface for driving a vehicle onto the structure at one end and off of the structure at the other end. The washing, collecting of runoff and recycling of washing fluid are all done similarly to the previous embodiments while permitting numerous vehicles to be washed in a more efficient manner.

While various embodiments of the present invention have been described in the foregoing, it is to be understood that other embodiments are possible within the scope of the invention. The invention is to be considered limited solely by the scope of the appended claims.

1. An apparatus for collecting liquid and debris runoff from a vehicle, the apparatus comprising:
a ramp structure having a pair of parallel and spaced apart ramps defining an opening therebetween extending in a longitudinal direction of the ramps and being arranged to support the vehicle thereon;
a primary collector spanning across the opening between the ramps such that substantially all liquid and debris falling between the ramps is collected by the primary collector;
a secondary collector spanning between respective sides of each ramp such that substantially all liquid and debris falling on the ramps is collected by the secondary collectors; and
a discharge associated with each collector for diverting liquid and debris collected by the respective collectors therethrough.

2. The apparatus according to claim 1 wherein the ramp structure extends at an upward incline from a bottom end to a top end, the discharge of each collector being located adjacent the bottom end of the ramp structure.

3. The apparatus according to claim 1 wherein the primary collector comprises a longitudinally extending trough and the corresponding discharge comprises an open end of the trough.

4. The apparatus according to claim 2 wherein there is provided a common collection tank in communication with the discharges of the respective collectors, the discharges of the respective collectors being spaced upwardly from the bottom end of the ramp structure so as to receive the common collection tank there below.

5. The apparatus according to claim 1 wherein the primary collector comprises a plurality of sections mounted adjacent to each other, each section being selectively separable from the ramp structure.

6. The apparatus according to claim 5 wherein the ramp structure extends at an upward incline from a bottom end to a top end, a bottom end of each section being arranged to overlap a top end of an adjacent section.

7. The apparatus according to claim 1 wherein the primary collector spans laterally between a pair of longitudinally extending sides, the sides being arranged to be supported on the ramps respectively.

8. The apparatus according to claim 1 wherein there is provided a spray cart supported between the ramps for rolling movement in a longitudinal direction of the ramps, the spray cart-having a plurality of upwardly extending nozzles for direction a flow of fluid upwardly to engage a vehicle supported on the ramp structure.

9. The apparatus according to claim 8 wherein the primary collector comprises a rigid trough having a pair of longitudinally extending rails formed integrally therein, the spray cart being supported for longitudinal rolling movement along the rails of the trough.

10. The apparatus according to claim 1 wherein each ramp comprises a plurality of longitudinally extending, parallel and spaced apart beams, each secondary collector comprising a plurality of longitudinally extending canals mounted between the respective beams of the corresponding ramp.

11. The apparatus according to claim 10 wherein the beams comprise I-beams having laterally extending flanges adjacent a top end thereof, the canals each having a pair of sides extending upwardly and outwardly beneath the respective flanges of adjacent beams.

12. The apparatus according to claim 8 wherein the spray cart is supported by a series of rollers arranged for rolling movement along the ramps.

13. The apparatus according to claim 12 wherein there is provided an adjustable mount supporting the rollers on the cart such that the rollers may be supported at any one of numerous lateral spacings therebetween for supporting the cart on ramps having various spacings therebetween.

14. The apparatus according to claim 1 wherein the primary collector is formed of a flexible material permitting a width of the primary collector to accommodate various lateral spacings between the ramps.

15. The apparatus according to claim 14 wherein there is provided a roller mounted integrally with the primary collector between the ramps and extending in the longitudinal direction of the ramps, the roller being supported for rotation about a longitudinally extending axis so as to permit the primary collector to be rolled up on the roller.

16. The apparatus according to claim 1 wherein there is provided a settling tank extending between respective first and second ends of the tank, the discharges of the respective collectors being arranged to communicate with the first end of the settling tank and a recycling station being arranged to communicate with the second end of the settling tank, the recycling station having a pump arrangement for drawing fluid from the settling tank and redirecting the fluid at a vehicle supported on the ramps.

17. The apparatus according to claim 16 wherein the recycling station includes a liquid separator for separating undesirable liquids from the fluid to be directed at the vehicle.

18. The apparatus according to claim 16 wherein the settling tank includes a series of baffles mounted at spaced apart locations between the first and second ends of the tank.

19. The apparatus according to claim 16 wherein there is provided a slurry pump and solid particle separator coupled to the first end of the settling tank arranged to remove an accumulation of solid particle debris from the first end of the settling tank.

20. The apparatus according to claim 2 wherein each secondary collector includes a respective flushing system mounted adjacent a top end thereof arranged to direct a flow of flushing fluid through the respective secondary collector from the top end to the discharge thereof.
